(19) United States
(12) Patent Application Publication
(10) Pub. No.: US 2023/0394679 A1
(43) Pub. Date: Dec. 7, 2023

(54) METHOD FOR MEASURING THE SPEED OF A VEHICLE

(71) Applicant: TRANSPORT ANALYSIS LTD, London (GB)

(72) Inventor: Samuel Gerard Bailey, London (GB)

(21) Appl. No.: 18/029,950

(22) PCT Filed: Sep. 28, 2021
(86) PCT No.: PCT/GB2021/052516

§ 371 Date: Apr. 3, 2023

(30) Foreign Application Priority Data
Oct. 4, 2020 (GB) 2015709.5
Aug. 4, 2021 (GB) 2111228.9

(51) Int. Cl. G06T 7/246; G06V 20/62; G06V 20/54; G06V 20/40; G08G 1/054; G08G 1/017

(52) U.S. Cl. CPC G06T 7/248; G06V 20/625; G06V 20/54; G06V 20/41; G08G 1/054; G08G 1/0175; G06T 2207/10016; G06T 2207/30252; G06T 2207/20084; G06T 2207/30241; G06V 2201/08

(57) ABSTRACT

A method for measuring the speed of a vehicle from a video motion capture by using the time elapsed between a first wheel of the vehicle reaching a reference position in the image and a second wheel of the vehicle reaching the reference position in an image.

This invention relates to a method for measuring the speed of a vehicle from a video capture.

Measuring the speed of moving vehicles is desirable for law enforcement and traffic enforcement across the globe. Excessive speed is a significant cause of road accidents, and leads to higher pollution and CO₂ emissions from vehicles.

Devices exist for measuring vehicle speeds; speed cameras. These are ubiquitous, and use typically use a doppler shift method whereby a beam of either radio waves (radar based) or light (lidar based) is emitted by the device, and the frequency shift of the reflected beam is used to determine the speed of a target relative to the emitter. They usually also include a camera, which is triggered by the doppler shift measurement, to take an image or video of the vehicle for number plate capture and enforcement.

It would be desirable to be able to determine the vehicle speed purely from the video capture. This would eliminate the need for the lidar or radar sensor, which adds cost and complexity to the speed camera. It also limits the deployment of the speed camera.

Some techniques for measuring vehicle speed from a video capture. However they are of limited accuracy, and require some precalibration step.

These techniques capture an image of a moving vehicle and attempt to estimate speed. The problem in measuring vehicle speed from a video capture is the translation from pixels per second in an image to metres per second in the real world.

A target vehicle can be tracked across an image using computer vision techniques known in the field, e.g. optic flow, neural networks, Kalman filters. This yields a vehicle velocity in pixels per second across a field of view.

Alternatively vehicle foreshortening can be measured. This yields a relative change in vehicle apparent size in the image.

The translation between pixels per second and meters per second is dependent upon several factors: the distance to the target vehicle from the camera, the camera Field of View angle (FoV), the degree of spherical aberration on the lens, the position of the vehicle within the field of view due to perspective shift,

Attempts to overcome these have previously relied on either physically measuring the distance to the vehicle, or estimating it which induces errors and are difficult to validate. Alternatively, they rely on marking fixed positions on the road, e.g. a series of stripes painted at fixed intervals, and measuring the vehicle position in each frame relative to the stripes.

These all mean that a video speed camera needs to be set up in a fixed location, which adds expense, or is of limited accuracy.

Other attempts to determine vehicle speed from video images include:—
Determining speed of rotation of a vehicle wheel and using the circumference of the wheel and rate of wheel rotation to provide speed [US2019/0355132]
Creating a model between physical position co-ordinates and image position co-ordinates, using fixed features of vehicles [e.g. wheelbase] to provide calibration of parameters in the model [CN109979206A].

The present disclosure provides a method that can accurately capture vehicle speed from an image capture without any knowledge of the camera lens, vehicle distance, scene geometry and with no fixed position markers.

The invention provides a method for determining the speed of a vehicle in a video sequence, wherein a time elapsed between a first wheel of the vehicle reaching a reference position in the image and a second wheel of the vehicle reaching the reference position in the image is determined, the speed of the vehicle being calculated based on knowledge of the distance between the wheels of the vehicle and time elapsed.

In essence, the wheelbase of the vehicle being measured is used as a scaling factor to determine the speed in real world units from the time between a first wheel and a second wheel reaching a reference position on the image.

The invention is illustrated by way of example in the following exemplary and non-limitative description with reference to the drawings in which:—

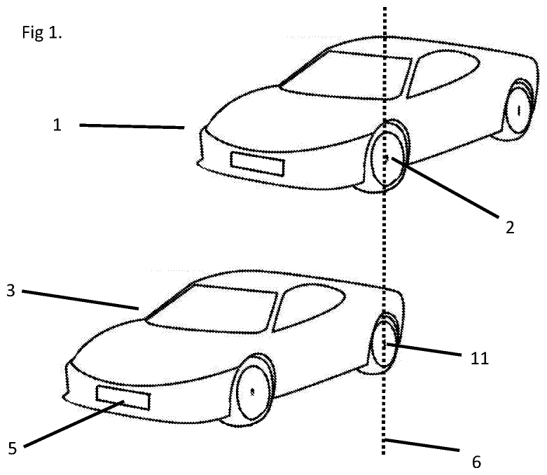

FIG. 1 exemplifies schematically one example of the method of the invention;

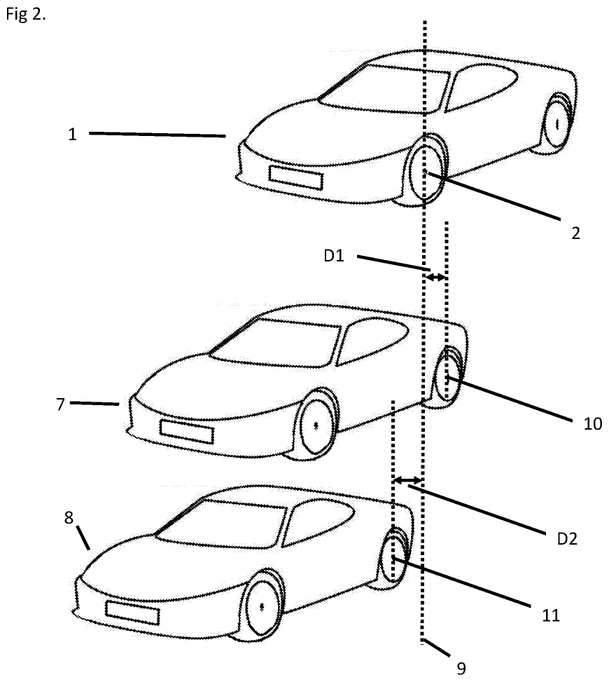

FIG. 2 exemplifies schematically a different example of the method of the invention.

In FIG. 1, a video capture of a vehicle is taken from the side, or an angle from which the side of the vehicle is clearly visible. Typically this can be up to 60 degrees from directly side on, but it could be more. Two image frames from the capture as the vehicle moves across the field of view are shown in FIG. 1, vertically offset for clarity.

A technique known in the field of computer vision, for example a neural network, or a circle finder such as a circular Hough Transform, or a template matching algorithm is used to locate the centre point 2 of a front wheel in a first frame 1. The invention is not limited to locating the centre of a wheel. Various portions of each wheel may be used in this method [e.g. a leading portion or a trailing portion of each wheel] but locating the centre of each wheel is generally most convenient.

As the vehicle moves across the scene, both visible wheels on the near side are tracked until a subsequent frame is found 3 where the centre point of the rear wheel 4, has the same horizontal position 6 on the image frame as the centre point of the front wheel did in the first frame. Although the horizontal position is used in the example as a reference position, it is apparent that the invention is not limited to using a horizontal position as a reference. If a vehicle is moving obliquely away from an imaging device a vertical position on the image could be used, or indeed a point in the image could be used as the reference.

The time, T, between the first frame 1 and the second frame 3 is determined, either by counting the number of frames between the first and second frames, and using the frame per second measure of the capture to determine the interval between the frames, or more preferably by using the time measurement between each frame capture which most digital video capture devices record, as this gives a more accurate measurement and allows for any jitter in the frame capture rate, and summing them to measure the time elapsed between frames 1 and 3.

In that time elapsed the vehicle has travelled the distance between the wheel centres and so the speed of the vehicle can be calculated if this distance (the wheelbase) is known.

In this method, the wheelbase, W, of the vehicle is then determined, either because it is already known to the system, or from or in conjunction with one or more external sources. For example, the license plate of the vehicle 5 may be determined and searched for in a vehicle information database which contains the vehicle details e.g. the vehicle is a 2018 Ford Focus Mk4 Hatchback which has a wheelbase of 2.70 m. Further examples for identifying the wheelbase are given below.

The speed of the vehicle, V, between the frames 1 and 3 can then be determined by dividing the wheelbase by the time between the frames

V=W/T

In practice, because the frames are captured at a discrete frame rate, the probability of a second frame having the rear wheel perfectly aligned with the front wheel is slim

In this case a second technique can be used as exemplified in FIG. 2.

The location of the centre point 2 of a front wheel in a first frame 1 is found and its horizontal position 9 is measured and stored. The wheels are then tracked through the subsequent frames. A second frame 7 is identified as a frame (preferably the last frame) before the rear wheel has crossed the stored horizontal position of the front wheel, and a frame after that 8 (preferably the first frame) after the rear wheel has crossed the stored horizontal position of the front wheel.

The time at which the rear wheel crossed the stored horizontal position 9 of the front wheel can thus be determined by using:—
the distance D1 between the position of the centre point 10 of the rear wheel in frame 7 and the stored horizontal position 9; and
the distance D2 between the position of the centre point 11 of the rear wheel in frame 8 and the stored horizontal position 9.

An interpolation technique known in the field, for example linear interpolation, can be used to determine the time at which the rear wheel crossed the stored horizontal position 9.

For example using linear interpolation the crossing time of the rear wheel TC can be found from

TC=T7+(T8−T7)×D1/(D1+D2)

where T7 is the time of frame 7, and T8 is the time of frame 8.

The difference between the time of frame 1, T1 and the interpolated rear wheel crossing time TC can then be used to calculate the vehicle speed, V in a similar manner as before

V=W/(TC−T1)

In an alternative embodiment, the position of the rear wheel may be calculated first and used to create the fixed horizontal position and the front wheel crossing time calculated relative to that. In another embodiment, the frames either side of the front wheel may be found and interpolated between, rather than the rear wheel.

In another alternative embodiment, the horizontal position may not be fixed based on a position of either wheel in a specific frame, but determined using another criteria, and both the front and rear wheels crossing times determined using an interpolation technique.

Further, although tracking is indicated above, this need not be continuous. For example it may be effective to:
identify a frame where a front wheel is shown and identify the centre or other portion of the wheel as a reference position
identify another frame where the rear wheel is shown beyond that reference position
to interpolate to identify a group of frames where the rear wheel is likely to have reached the reference position
to identify among those frames which frame of frames best enables the determination of when the centre of the rear wheel reached the reference position.

In order to improve the robustness, several additional features may or may not be present.

The precise position of the centre (or other reference point) of the vehicle wheel is critical to the accuracy of the speed calculation. Techniques known in the field, for example finding the best line or lines of symmetry in the wheel portion of the image, or the best centre of rotational symmetry, or the best fit to a circle finder algorithm may be used to improve the accuracy of the wheel centre position. Finding another reference point on a vehicle wheel (for example leading edge or trailing edge of a wheel) is likely to be both less accurate and more difficult, but is not excluded from the invention.

Several vehicles may be visible in the camera field of view, for example if it used in traffic or near parked vehicles. The wheels detected must therefore be matched to the vehicles they belong to.

The tracking of the wheels from frame to frame may be improved by using techniques known in the field e.g. projecting a velocity vector across the image to ensure that the estimated wheel position does not deviate from a physically viable line. Alternatively or additionally a Kalman filter or similar predictor corrector algorithm may be used to estimate the positions of the wheels in each frame to improve tracking.

The difference in the velocity vectors of the front and rear wheels may be compared to a threshold to determine whether the tracked wheels are on the same vehicle (rather than being from different vehicles that are both in the field of view).

The velocity vectors of the tracked wheels may be compared to known viable trajectories to reject spurious tracking errors.

The images captured may be passed through a vehicle tracking algorithm, for example a deep neural net, that has been trained to recognise vehicles. The boundary or bounding box of the vehicle can then be used to match the wheels found in the image to the vehicle. The boundary of the vehicle can also be used to ensure that the license plate found is inside the vehicle boundary, and hence is from the same vehicle as the wheels that are tracked.

The license plate may be recognized and tracked over multiple frames and its velocity vector found. The velocity vector may then be compared to the velocity vector of the wheels and/or the vehicle to minimise the possibility that the licence plate is from another partially obscured vehicle. Other visual cues such as the colour of the vehicle in the region of the license plate and the wheels may be used to confirm the match.

A vehicle recognition neural net may also be trained to recognise vehicle types and models. In this case the recognised vehicle model may be used in conjunction with a library of vehicle wheelbases to determine the wheelbase, rather than using the license plate. The recognised vehicle type may also be compared to the vehicle type recovered from the license plate. If these do not concur then they may indicate either a misreading of the license plate, or a vehicle with fake or unregistered numberplates. In this case the information could be used to report to law enforcement.

The system may also perform aggregate calculations or summary reports. For example it could record the proportion of vehicles in a given location that are exceeding the speed limit, or the highest speeds that are recorded in a given location.

The optic flow or movement of the regions of the image between the wheels may be measured and compared to the movement of the wheels to determine if they are all located on the same vehicle.

The angular rotation of the wheels in the image may be detected by image recognition, and knowledge of the diameter of the wheels used to convert the rotation in angular velocity to velocity along the road as a check against the value determined from the claimed method.

The method described may also track more than 2 visible near side wheels, for example from a 6 or more wheeled vehicle. In this case the detected wheels may be measured when crossing the fixed horizontal position and the distance between the different sets of axles used to determine the speed in the manner described previously. The algorithm may also track the position of 2 wheeled vehicles and measure their speed in the same manner as above.

In some instances the wheelbase may not be precisely known, but bounds on the possible wheelbase lengths can be used to infer bounds on the possible speeds that the vehicle was doing.

The accuracy of the measurement will be affected by any movement of the camera between the frames used to measure the vehicle speed. If the camera is on a movable device (e.g. a handheld smartphone, or mounted on a pole that could be subject to oscillations, or in a vehicle or some other moving position), then the motion of the camera could be measured. This could be used to apply a correction to the vehicle speed measurement. Alternatively the measurement could be rejected if the camera motion was above a threshold that would make the speed measurement insufficiently accurate.

The camera motion may be measured by accelerometers or gyroscopic sensors. Alternatively or additionally the video capture may be analysed to measure camera motion. Portions of the image away from the vehicle target e.g. the top or bottom section of the image, where the image contains a fixed background object, can be used to measure the camera movement by calculating for example the optic flow of a background section of the image by a technique known in the field. The measured camera movement can then be used to either calculate a correction to the measured speed, or to reject the capture if the movement is above a threshold which would render the speed measurement insufficiently accurate.

The camera may also record location and time information, e.g. by GPS or some other manner, to provide evidence of the time and location the speed was measured.

The location information may be combined with data on speed limits in the location to determine if a speeding offence has taken place.

When the camera location is close to a road junction, it may be ambiguous from the location alone, and also the error on the GPS position, which road the vehicle is travelling on. If this is the case, the compass heading of the capture device or a pre-programmed setting, may be used to determine which road the vehicle is travelling on, The angle and direction of the vehicle motion across the field of view may also be used to determine which road the vehicle is travelling on. For example on a cross roads with one road passing East-West and one North-South, if the camera is facing NE, if the vehicle wheels travel up and left in the image, the vehicle is travelling East on the East-West road. If they are travelling up and right, they are travelling North on the North-South road, down and left, they are travelling South and down and right, they are travelling West.

The video data, and/or associated metadata, may be digitally signed by a method known in the field e.g. hashing, to demonstrate that the data has not been tampered with.

The timing signals from the capture device may also be recorded and compared to a known calibrated time to detect any errors in the timing measurements on the device.

The capture frames may be recorded and annotated with the tracked wheel position and timestamp of the frames and used to present as evidence of the vehicle speed.

The speed of the vehicle can be measured using two or more reference positions on the image and the acceleration of the vehicle estimated from the change in speed at each image position, and the time between a vehicle wheel reaching each position.

Other possibilities for the disclosed methods will be apparent to the person skilled in the art, and the present invention is not limited to the examples provided above.

What is claimed is:

1. A method for determining the speed of a vehicle in a video sequence taken from an angle from which the side of the vehicle is clearly visible, wherein a time elapsed between a first wheel of the vehicle reaching a reference position in a first image and a second wheel of the vehicle reaching the reference position in a second image is determined, the speed of the vehicle being calculated based on knowledge of the distance between the wheels of the vehicle and time elapsed; and
the time elapsed being determined as the difference between the time the centre of the first wheel of the vehicle reaches the reference position in the first image and the time the centre of the second wheel of the vehicle reaches the reference position in a second image.

2. A method as claimed in claim 1, wherein the position of the wheels of the vehicle are tracked across multiple frames in the video sequence.

3. A method as claimed in claim 2, wherein a difference in velocity vectors of the first and second wheels is compared to a threshold to determine whether the tracked wheels are on the same vehicle.

4. A method as claimed in claim 2, wherein velocity vectors of the tracked wheels are compared to known viable trajectories to reject spurious tracking errors.

5. A method as claimed in claim 2, wherein a license plate is recognized and tracked over multiple frames and its velocity vector found, the velocity vector of the license plate being compared to the velocity vector of the wheels and/or a velocity vector of the vehicle.

6. A method as claimed claim 2, wherein a boundary of the vehicle is identified and used to ensure that a license plate found is inside the vehicle boundary, and hence is from the same vehicle as the wheels that are tracked.

7. A method as claimed in claim 1, wherein the time of one or both of the first wheel or the second wheel reaching the reference position in first or second image is determined by interpolation based on the location of the wheel in one or more images where the wheel has not reached the reference position, and the location of the wheel in one or more images where the wheel has passed the reference position.

8. A method as claimed in claim 7, where the interpolation is linear.

9. A method as claimed in claim 1 wherein the location of the first wheel in a first image is used to define the reference position.

10. A method as claimed in claim 1 wherein the reference position is a horizontal position in the image.

11. A method as claimed in claim 1 wherein the location of the wheels in the image is determined using a neural network.

12. A method as claimed in claim 1, wherein the wheelbase of the vehicle is:
a) pre-programmed into the system; or
b) determined by reading a license plate and using one or more vehicle information databases to determine the wheelbase; or
c) determined by recognition of the vehicle make and model from the image; or a combination thereof.

13. A method as claimed in claim 12, wherein a vehicle model determined by reading the license plate is compared with the vehicle model determined from the image, to indicate:
a potential misreading of the license plate; or
a fake or unregistered numberplate.

14. A method as claimed in claim 1, wherein one or more of:
the location of the video sequence,
the date and time of the video sequence,
the frames used for the wheel position capture; and
the timestamps of the frames used for the wheel position capture are recorded along with the video sequence for use as evidence.

15. A method as claimed in claim 14, wherein some or all of the recorded video sequence and metadata are digitally signed.

16. A method as claimed in claim 1, wherein the geographic location of the video sequence is used to look up a local speed limit to determine whether a speed limit has been exceeded.

17. A method as in claim 16 wherein the geographic location of the capture is taken from a GPS or other positioning system measurement in the device taking the capture.

18. A method as in claim 16 wherein a compass heading of the capture device is used to determine which road the vehicle is travelling on.

19. A method as in claim 18 wherein the angle and direction of the vehicle motion across the field of view of the capture device is also used to determine which road the vehicle is travelling on.

20. A method as claimed in claim 1, wherein the video sequence is obtained from an imaging device, and motion of the imaging device during the video sequence is determined to:
compensate the determined speed of a vehicle for motion of the imaging device; or
reject speed measurements where the motion of the imaging device is higher than a threshold.

21. A method as claimed in claim 20, wherein motion of the imaging device during the video sequence is determined by measuring the motion of background parts of the image away from the vehicle being tracked.

22. A method as claimed in claim 21, wherein the threshold is a function of the measured vehicle speed.

23. A method as claimed in claim 20, wherein motion of the imaging device during the video sequence is measured by a motion sensor in the imaging device.

24. A method as claimed in claim 1, in which the video sequence is obtained from a capture device and timing signals from the capture device are recorded and compared to a known calibrated time to detect any errors in the timing measurements on the device.

25. A method as claimed in claim 1, in which the video sequence is obtained from a capture device and capture frames are recorded and annotated with the tracked wheel position and timestamp of the frames.
